(19) United States
(12) Patent Application Publication
(10) Pub. No.: US 2007/0013723 A1
(43) Pub. Date: Jan. 18, 2007

(54) Magnification engine and interface for computers

(75) Inventors: Jeremy de Souza, Redmond, WA (US); Matthew B. Karr, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/180,859

(22) Filed: Jul. 12, 2005

(51) Int. Cl. G09G 5/00

(52) U.S. Cl. 345/660

(57) ABSTRACT

Described is an engine and API that couples an application program to an effects program such as a magnification program. For example, source content may be magnified for viewing in an output region. Magnification may be accomplished by identifying a magnification window to the magnification engine, a source region to magnify, a magnification transform, and possibly filtering criteria, such as any windows to include or exclude from magnification. A request to display a region of displayed graphics as modified by a transform may be received, and when graphics commands corresponding to that region are received, the graphics commands are processed to show a transformed representation of the region. The engine and API may work with immediate mode graphics primitives (e.g., GDI commands) and retained mode graphics primitives (e.g., primitives corresponding to a rendering tree; a composition engine composes the output, including any magnified output.

### BACKGROUND

Contemporary computer systems offer users the ability to magnify a portion of their display screen, typically for providing visually-impaired users with better accessibility to computers, although also offering mainstream users the benefit of magnification in certain contexts. The portion of the display screen that is magnified can be selectively based on where the mouse is located, where the keyboard is focused, and/or where the user is otherwise editing, e.g., when selecting content such as for cutting and pasting.

In general, when the user runs a magnifier, a magnification window is opened and the magnified content displayed in that window. The user can adjust the magnification window in size and position, adjust the magnification level, and possibly choose other effects, e.g., color inversion. One such magnifier program operates by driver hooking, to intercept graphics calls sent towards the video driver, essentially in a screen capture operation, where the magnifier program then scales up a corresponding graphics image in the magnification window.

While such a magnifier thus provides benefits to computer users, in general, existing magnifiers are relatively limited. For example, a magnifier that relies solely on screen capture provides a relatively low quality and low performance magnification solution. Further, magnifier application programs cannot be easily leveraged by other programs.

### SUMMARY

Briefly, various aspects of the present invention are directed towards an engine and application program interface that couples an application program to an effects program such as a magnification program. In this way, any source content may be magnified or otherwise altered (e.g., skewed) for viewing in an output region, e.g., a designated output window.

In one example implementation, a magnification engine is provided, along with an interface set by which an application program can couple to a magnification program. This may be accomplished by identifying a magnification window to the magnification engine, along with identifying a source region to magnify, a magnification transform, and possibly filtering criteria, such as any windows to specifically include or exclude from magnification.

In another example implementation, a computer-readable medium having computer-executable instructions executes steps, including receiving a request to display a region of displayed graphics as modified by a transform. Upon receiving data corresponding to graphics commands for that region, the graphics commands are processed so that a program-specified output area shows a transformed representation of the region.

In another example implementation, a system includes a graphics server that receives immediate mode graphics primitives from a first program and retained mode primitives from a second program. A magnification engine is coupled to the graphics server, and has an interface set for coupling to a magnification program. The graphics engine provides at least some data corresponding to the immediate mode graphics primitives and retained mode primitives to the magnification program for magnification prior to sending to the composition engine, for composing graphical output including magnified output.

Other advantages will become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a flow diagram representing example steps in providing a magnifier in accordance with various aspects of the present invention.

FIG. 3 is a block diagram representing an example implementation for magnifying text and graphics in accordance with various aspects of the present invention.

FIG. 4 is a block diagram representing various components within an example magnification engine in accordance with various aspects of the present invention.

### DETAILED DESCRIPTION

Exemplary Operating Environment

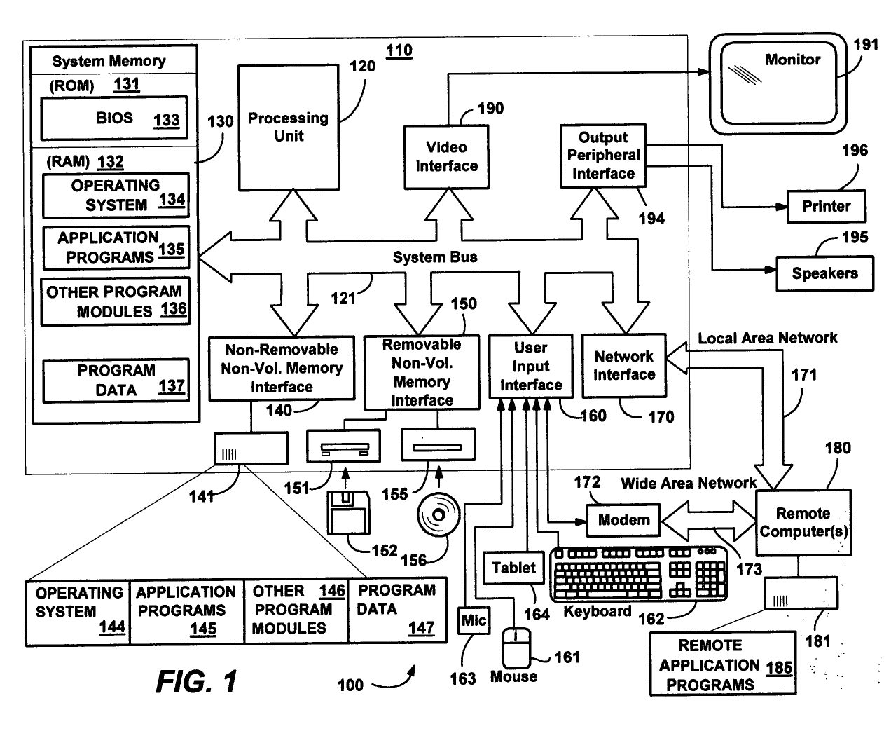

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, described above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Magnification Engine and API

Various aspects of the technology described herein are directed towards providing a platform on which magnification application programs, particularly high-quality programs, may be built. At the same time, the present invention provides a mechanism by which other programs, including mainstream application programs such as word processing and spreadsheet programs, may easily provide magnification functionality.

In general, this is accomplished by a magnification engine and application program interface that provides much of the functionality needed to couple a magnification application program to a computer system, such as via operating system components. In one example implementation described herein, the magnification engine and interface are described in the form of a Win32 control that may be hosted by any application program, or run independently (e.g., via an operating system shell). However, as will be understood, the present invention is not limited to controls in general or a Win32 control, let alone any particular implementation or examples described herein. Instead, numerous ways to implement the present invention are feasible, and as such, the present invention is not limited to any of the particular examples used herein, but rather may be used various ways that provide benefits and advantages in computing in general.

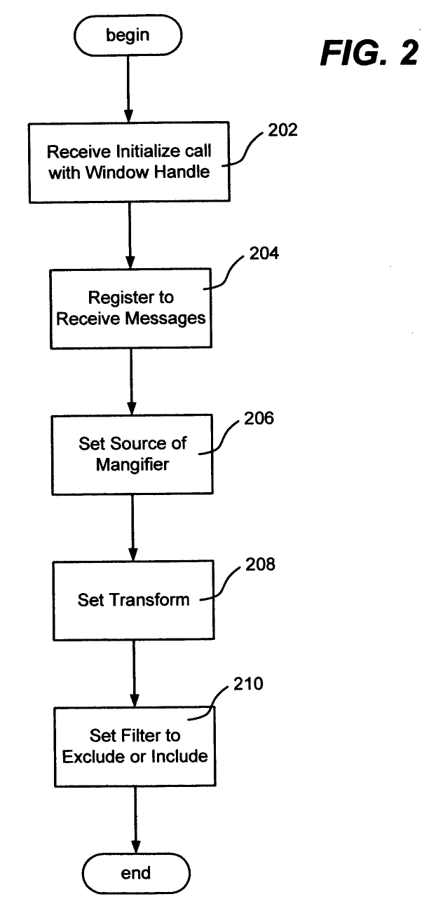

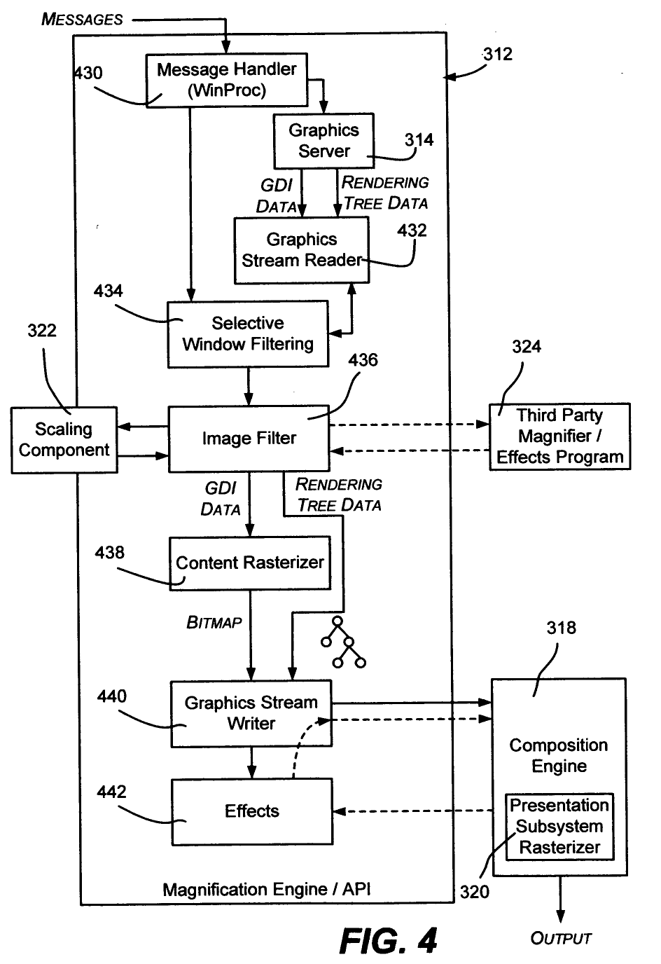

Turning to FIG. 2 of the drawings, there is shown a general flow diagram for operating a magnifier, as described herein in the form of a control. In general, any program window may be a magnification window, and thus, for example, a program may open a window like a dialog or other pop-up window and use it for showing magnified images of another region of the screen. To set up a window as a magnification window, a program receives a window handle (hwnd) in a regular manner, e.g., in one implementation, magnification windows are created via the CreateWindow API, and such windows may be shown, hidden and subclassed like any other common control. The paint code for these windows uses the magnification stack to draw a transformed copy of the desktop. Like other windows, the program may specify a clip region or an alpha layer to further control output, e.g., via SetWindowRgn. The magnification window rendering stack (described below with reference to FIG. 4) uses the window clip to reduce the amount of processing required.

Once created, the program calls an initialize function of a magnification engine/API (via an application program interface), providing the handle. This is generally represented in FIG. 2 via step 202; note that various functions of the magnification engine/API are set forth below.

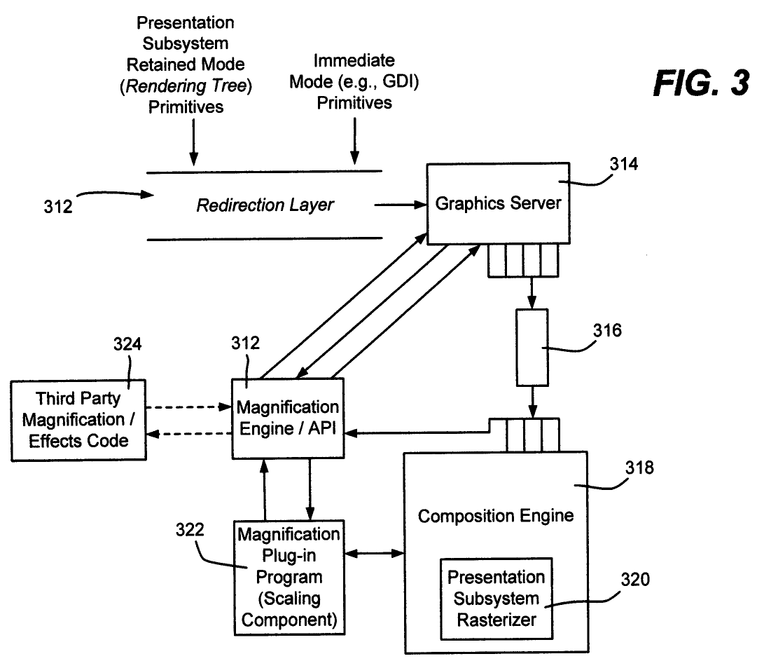

Step 204 represents the magnification engine/API 310 (FIG. 3) registering to receive window messages. Note that in this example environment, driver hooking is unavailable, or at least undesirable, and thus the magnification engine/API obtains graphics commands via the windowing message queue.

The caller of the API, typically the shell or other application program, also identifies the region to be magnified, which may be any practical rectangle up to the entire desktop. This is represented via step 206, where the caller identifies the magnification source. Note that the magnification source can change; for example, a window may surround the mouse pointer, e.g., with the mouse pointer centered therein. As the mouse pointer is moved, the source changes, so that everything under the mouse pointer appears magnified as the mouse pointer moves over it. Note that such a mouse-pointer-magnification window alternatively may be fixed on the desktop, however the source may still change with the mouse pointer and thereby change the contents of the magnification window.

Some consideration is given to the system mouse cursor. Mouse behavior may depend on application-specific policy. It is up to the host application to add any scenario specific mouse handling.

For example, the cursor may be above the magnification window, but the magnification window will not hit-test for mouse clicks. As a result the clicks will go through to the window underneath the magnification window. This can cause confusion, such as when the system cursor is located underneath the output window but not inside the source rect; it will then be over an area of user interface that the user cannot see, referred to as the “dead zone.” One solution is to explicitly render a magnified cursor in the output in addition to the system cursor. A flag (MS_SHOWMAGNIFIEDCURSOR) allows the owning application to show and hide the magnified cursor. Another flag (MS_CLIPAROUNDCURSOR) causes the magnifier window to clip out an area around the system cursor when it is in the dead zone.

Step 208 represents obtaining the transform that is (typically) used for magnification level, e.g., 2×, 3×, and so forth. Note that the transform can designate something other than magnification, e.g., skew, and that if magnification is used, the magnification may be 1× (no magnification) or some fraction smaller than 1×, e.g., a reduced size image may be shown. Thus, although the present invention is primarily described herein with reference to magnification, any transform, including an identity transform that does not technically magnify or reduce, may be applied. Note that the output rect is essentially ignored by the magnification process; if the magnification factor is too small, the output will not fill the magnification window. If the magnification factor is too large, the output will be clipped. In both cases the output is anchored at 0,0 in the output window.

Step 210 represents the concept of selective window magnification, or filtering. More particularly, not everything in a designated region needs to be magnified. Instead, the magnification engine/API allows the program to designate which windows to magnify, and which ones should be excluded from the final magnified output. Note that the magnifier window never magnifies itself, although it would be feasible to do so.

Filtering may be via inclusion or exclusion. Thus, a program may specify a list of windows to include (but not the magnification window) or elect to magnify all windows except those specifically excluded (the magnification window will be excluded). In this manner, a program has significant flexibility as to what gets magnified.

Once the magnification engine/API 310 is configured, FIG. 3 shows how the magnification engine/API 310 generally operates. FIG. 3 shows an example graphics processing configuration in which possibly different types of graphical data are provided by application programs and the like for rendering on a display. One well-known type of graphical output is immediate mode graphics, in which an application provides instructions (e.g., GDI primitives) to draw content (i.e., text and graphics) directly onto the display. Another type of graphical output is retained mode graphics, such as from a program of a presentation subsystem that provides drawing primitives from which a screen graph, or rendering tree, is constructed on a surface for that program. The rendering tree is then processed to obtain the appropriate output. For purposes of explanation herein, “GDI” is typically used to refer to the primitives and content that programs intend for immediate mode graphics (even if actually retained via redirecting to a surface), while “rendering tree” data is used to refer to the primitives and content that programs intend for retained mode graphics.

In order to composite immediate mode graphics and retained mode graphics, a redirection layer 312 essentially sends the GDI graphics to a surface, as if the immediate mode graphics were retained mode instructions. A graphics server 314, typically including a rasterizer or the like for handling GDI primitives, provides a graphics stream 316 containing one or more bitmaps and/or primitives from the various surfaces to a composition engine 318. The composition engine then composites the various output from the surfaces, and sends composited graphics data to a graphics card to render the graphical output.

In one implementation, for each set of GDI data, the graphics stream 316 may comprise a rasterized bitmap. This is because in this implementation, the composition engine 318 only includes a rasterizer 320 for the presentation subsystem's primitives (that correspond to a rendering tree), and does not rasterize GDI primitives.

Note, however, for GDI data that is to be magnified, the GDI primitives may be sent in the stream for processing by a magnification engine/API 322 and its connected components, which will rasterize the primitives prior to sending to the composition engine 320. More particularly, one way to magnify visible content is to scale the content using its rasterized bitmap, as is done is conventional magnification. However, this generally provides a low quality and low performance result, but nevertheless is reasonable for existing immediate mode programs. Alternatively, by changing data of the primitives, e.g., doubling font size, line lengths and so forth for 2× magnification, magnification with better quality and performance is obtained.

FIG. 3 conceptually shows that part of the graphics stream is directed towards the magnification engine/API 312. As described above, to receive graphics primitives in an environment without driver hooking, the magnification engine/API registers for window messages. In general, any part of the graphics stream that is to be magnified is first sent to the magnification engine/API 3. This allows pre-processing and transforming of the graphics primitives, which generally comprises scaling.

Scaling may be accomplished by a plug-in client scaling component 322. Alternatively, or in addition to, magnification and other effects may be accomplished by a separate magnification effects program, referred to herein as a “third party” program 324, even though there is no intent to limit such a program to any particular vendor, and indeed, the provider of the magnification engine/API may also provide such a program. This provides extensibility, for example, as better magnification/effect programs become available, such as better quality bitmap magnification programs. Alternatively, an application that wants to implement its own StretchBlt algorithm (possibly with a different smoothing algorithm) can do so by setting the magnification transform to the desired transform, and then performing magnification in its own filter. Setting the transform is necessary for the presentation subsystem (e.g., Avalon/Media Integration Layer) primitive scaling which is not handled by the extensibility point. In one implementation, applications handle their own magnification via a SetMagnifierImageFilterCallback function.

In general, at least one component for performing magnification is available.

For the magnified part of the stream, the magnification engine 312 thus may process the primitives and/or bitmaps as configured, and return the modified data to the graphics server and/or composition engine as appropriate. If still further (e.g., non-scaling) effects such as color effects are desired, the graphics server 314 and/or composition engine 318 may again call the magnification engine/API 312 for routing to the appropriate effects code. This is represented in FIG. 3 by the arrows between these components.

With respect to the rendering tree primitives, magnification or the like is straightforward, as a transform node may be added to the rendering tree by modifying the primitives. As mentioned above, GDI primitives may be transformed prior to rasterization to accomplish magnification and the like, or the GDI primitives may be rasterized into a bitmap, with the bitmap magnified in a known manner, e.g., as conventionally accomplished. In any event, the graphics stream 316 ultimately contains the various surfaces comprising primitives and/or bitmaps, including the data corresponding to the magnified content.

FIG. 4 shows the various components, including further detail of the magnification engine/API 312. A message handler component 430 receives the messages that come into the registered control, as described above. This is the WinProc for the actual magnification window that handles incoming messages (matching the public APIs) and calls the appropriate internal components.

A graphics stream reader component 432 works with a selective window filtering component 434 so that only GDI data and rendering tree data from the graphics server 314 that correspond to included, or non-excluded, windows are processed for magnification. In one implementation, the graphics stream reader component 432 is a client of a Graphics Pipe (stream) API, and receives the raw packets from the graphics stream and hands them off to the selective window filtering component (HWND packet filter) 434. The selective window filtering component 434 filters the packets from the graphics pipe reader component based on the HWND associated with each packet. Magnifier HWNDs are always filtered out, and the inclusive or exclusive list of HWNDs is used to further filter the packets.

For relevant messages, that is, for source windows (e.g., based on their HWNDS) that are to be magnified, an image filter 436 works with the scaling component 322 and/or a third party magnifier 324 to scale the image, in the example of FIG. 4 by modifying the primitives. In general, the image filter 436 implements the callback mechanism for the plug-ins to implement custom image filtering code.

GDI content is then rasterized by a content rasterizer 438 prior to passing to a graphics stream writer 440, while rendering tree data is passed in its modified form to the graphics stream writer 440, where it will be rasterized. The content rasterizer 438 is responsible for rasterizing and compositing the packets. This component exposes three significant properties, namely transform, clip region (combines the source rect with the output clip from the output window) and output surface, where the output surface size is based on the clip region and transform.

The content rasterizer 438 is coupled to the graphics stream writer (composition engine writer) 440 to communicate with the graphics server and compose the magnified region of the desktop with the rest of the desktop. In this manner, the magnified data reaches the composition engine 318 in the appropriate graphics stream.

The magnified data may be returned to the magnification engine/API 312 for post-processing to add any effects, shown via effects component 442. In general, the effects component 442 implements the mechanism for other (e.g., third party) code to implement custom color effects. Note that although not specifically shown as such in FIG. 4, plug-in effects, such as the third part magnifier effects program 324 may be coupled to the effects component 442 to accomplish the desired effects. An application that wants to apply its own effects may do so by implementing effects in a a custom pixel shader routine which is registered via the SetMagnifierColorEffectsShader function.

In this manner, magnification programs may be easily coupled to the computer system, while because the magnification API enables a magnifier to be implemented as a Win32 control, the magnifier control may be dropped into any suitable application program. It is possible to build a magnification client that enlarges a control and refreshes as the user moves from control to control.

Moreover, as a control, multiple magnifier windows may be provided. They may reference the same source view with different scale factors, or different source views and/or scale factors. For optimization, when the same source view is to be magnified with different scale factors, the source data is only provided once to the magnification engine/API 312.

As described above, pre-composition filtering is available, whereby a program may plug-in a custom filtering mechanism before the magnification engine composites the images. Post-composition filtering also may be plugged in, to operate after the magnification engine composites the images. Note that text will be rasterized automatically at the post-magnification target resolution.

More particularly, rendering tree primitive calls generally reference indices in a glyph bitmap cache. Currently these bitmaps are rasterized for the default screen resolution, and there is no way to produce a text string from the sequence of cache indices. The magnification engine will obtain another copy of the image but rasterized at the post-magnification scaled resolution. The GDI text primitives will be re-rendered for the post-magnification scaled resolution. This applies to situations where the GDI text primitives are available.

Example API Functions and Structures

Magnification Window Creation

A first step is for developer to use the MagnificationInitialize( ) function to create a magnification window from any window having a handle, HWND. The magnification window behaves like a common control. The HWND for the created control is used as the first parameter to the other methods of the magnification API.

Window Styles

MS_SHOWMAGNIEDCURSOR

Setting this flag will cause a magnified image of the cursor to be displayed in the output.
   MS_CLIPAROUNDCURSOR
Setting this flag will cause the magnified window to be clipped in an area under the system cursor. This is to let the user see (if only partially) the UI that is really under the cursor.
   MS_INVERTCOLORS
Setting this flag will cause the contents of the magnifier window to be color inverted.
   Window Messages
These are the window messages that the Magnifier control understands. They are sent using the SendMessage API.
   MGM_SETSOURCE
Sets the source rectangle to be magnified.
WPARAM: NULL
LPARAM: a *RECT with a rectangle in screen coordinates that the target rectangle should be set to.
Returns: 0 for success
   MGM_GETSOURCE
Retrieves the source rectangle that is currently being magnified.
WPARAM: NULL
LPARAM: a *RECT that will be filled with a rectangle in screen coordinates of the target rectangle.
Returns: 0 for success
   MGM_SETTRANSFORM
Sets the transform applied to the source rectangle for output. Typically this is used to scale the output.
WPARAM: NULL
LPARAM: a *TRANSFORM, specifying the Transform to use.
Returns: TRUE for success
   MGM_GETTRANSFORM
Returns the transform applied to the source rectangle.
WPARAM: NULL
LPARAM: a *TRANSFORM, which will be filled with the current transform.
Returns: 0 for success
   MGM_SETFILTERLIST
Sets the list of HWNDs used for filtering. Magnifier windows are always filtered (i.e., excluded or not included). This list is either the inclusion list of windows to be magnified or the exclusion list of windows to be filtered.
WPARAM: An int which is the number of HWNDS in the filterlist
LPARAM: a *FILTERLIST, specifying the list of HWNDs to filter and the new filter mode.
Returns: TRUE for success, FALSE for failure
   MGM_GETFILTERLIST
Copies the count HWNDs to caller allocated array of HWNDs.
WPARAM: The count of HWNDS to copy over.
LPARAM: a *FILTERLIST which is filled in with the current filtermode and up to count members of its hwndList will be filled. The hwndList points to memory allocated with enough space for count HWNDS.
Returns: An int representing the current number of HWNDs in the list. Call it once with a count of 0 (zero) to query the number of HWNDs, to allocate a proper amount of space in the FILTERLIST.
   MGM_SETPREFILTERCALLBACK
This function sets/registers the callback function for external image filtering/scaling code. The function specified by the callback will be called by the magnification engine for rasterized GDI bitmaps before they are composited. The callback returns a processed bitmap back to the magnification engine.
WPARAM: NULL
LPARAM: *(*FilterFunction)(HWND hwnd, HBITMAP *bm, SIZE *bs))—A pointer to the callback function
Returns: 0 for success
   MGM_GETPREFILTERCALLBACK
Returns the registered callback function. If no callback is registered, the function returns NULL.
WPARAM: NULL
LPARAM: NULL
Returns: a function pointer to the function if the callback is set, NULL if no callback is set.
   MGM_SETCOLOREFFECTCALLBACK
This message sets/registers the callback function for external image color correction code. The function specified by the callback will be called after image composition has taken place. If a callback is registered, composited bitmaps will be passed to the function specified by the callback.
WPARAM: NULL
LPARAM: *(*FilterFunction)(HWND hwnd, HBITMAP *bm, SIZE *bs)) ))—A pointer to the callback function
Returns: 0 for success
   MGM_GETCOLOREFFECTCALLBACK
Returns the registered callback function. If no callback is registered, the function returns NULL.
WPARAM: NULL
LPARAM: NULL
Returns: a function pointer to the the function if the callback is set, NULL if no callback is set.
   Structs
   TRANSFORM

A 3×3 array of floats specifying an arbitrary 2D transform.

typedef struct tagTRANSFORM
{
float v[3][3];
} TRANSFORM, *PTRANSFORM;

FILTERLIST

A DWORD representing filter mode, and a pointer to a list of HWNDs to filter on.

```
typedef struct tagFILTERLIST
{
    DWORD filterMode;
    HWND *hwndList;
} FILTERLIST, *PFILTERLIST;
```

Possible values for filterMode are:
   MW_FILTERMODE_EXCLUDE
Do not render any of the windows listed in the hwndList into the magnifier window.
   MW_FILTERMODE_INCLUDE
Render only the windows listed in the hwndList into the magnifier window.
   MagnificationInitialize( )
BOOL MagnificationInitialize( );
Initializes the magnification library. This includes that the magnifier window class will be registered. Calling this API more than once is allowed. Each successful call to MagnificationInitialize should be matched with a call to MagnificationUninitialize. Returns true if successful.
   MagnificationUninitialize( )
BOOL MagnificationUninitialize( );
Uninitializes the magnification library. The magnifier window class is unregistered.
Returns false if the magnification has not already been initialized.
   SetMagnifierWindowSource
BOOL SetMagnifierWindowSource(HWND hwnd, RECT rect);
This API sets the source rectangle for the magnifier window. The hwnd passed to the method is for the magnification window itself. The rect is in desktop coordinates and specifies the area of the desktop that is magnified. This rectangle may span multiple monitors.
Returns true if the operation is successful.
   GetMagnifierWindowSource
BOOL GetMagnifierWindowSource(HWND hwnd, RECT *pRect);
Returns the source rectangle for the magnifier window. The hwnd passed to the method is for the magnification window from which the source rectangle is being requested. The rectangle is in desktop coordinates. Returns true if the operation is successful.
   SetMagnifierWindowTransform
BOOL SetMagnifierWindowTransform(HWND hwnd, TRANSFORM *pTransform);
Sets the transform applied to the source rectangle for output. Typically this is used to scale the output. The transform matrix is specified as an array of floats.
A basic usage of this method is to the scale the window by a certain factor.
The transform matrix, where x represents the scaling factor:

$$\begin{matrix}[ x & 0 & 0 ] \\ [ 0 & x & 0 ] \\ [ 0 & 0 & 1 ]\end{matrix}$$

GetMagnifierWindowTransform
BOOL GetMagnifierWindowTransform(HWND hwnd, TRANSFORM *pTransform);
Returns the transform applied to the source rectangle. The results are returned in a caller allocated structure.
Returns true if the operation is successful.
   SetMagnifierWindowFilterList
BOOL SetMagnifierWindowFilterList(HWND hwnd, DWORD dwFilterMode, int count, HWND *pHWND)
Sets the list of HWNDs used for filtering. Magnifier windows are always filtered. This list is either the inclusion list of windows to be magnified or the exclusion list of windows to be filtered.
The dwFilterMode can be one of the following:
   MW_FILTERMODE_INCLUDE
   MW_FILTERMODE_EXCLUDE
The count parameter is used to specify how many HWNDs are being passed to the API to be filtered.
Returns TRUE if operation is successful. Note that one implementation of this function requires LDDM capable video cards; it will return false on XPDM.
   GetMagnifierWindowFilterList
int GetMagnifierWindowFilterList(HWND hwnd, DWORD *pdwFilterMode, int count, HWND *pHWND)
First do a Get with a count of 0 to get the full count.
Returns the count of HWNDs in the list. Returns the filter mode in *pdwFilterMode. Copies the count HWNDs to caller allocated array of HWNDs.
To initially determine the appropriate count to pass to the method users should pass 0 (zero) as the count parameter. The return value from this call is the number of HWNDs in the list and may be used in a successive call to the method as the count parameter. Note that one implementation of this function requires LDDM capable video cards; it will return false on XPDM.
   SetMagnifierImageFilterCallback
BOOL SetMagnifierImageFilterCallback (HWND hwnd, void (*filter)(HWND hwnd, HANDLE bm, SIZE *bs));
This function sets/registers the callback function for external image filtering/scaling code. The function specified by the callback will be called by the magnification engine for all rasterized GDI bitmaps before they are composited. When we callback the registered function, we pass a handle to video memory. We expect the callback function to process the image referred by the handle using hardware accelerated methods. They could transfer the image to system memory and process it using software acceleration but this would impact overall performance of the magnification application.
After the callback function returns, the bitmap in video memory can have two possible size states:
   1. Unscaled—returned bitmap is same sized as bitmap passed to the caller. The API will then do the scaling by the TRANSFORM specified to the SetWindowTransform function.
      2. Scaled—returned bitmap is scaled by the TRANSFORM specified to the SetWindowTransform.
This callback mechanism will allow third parties to implement custom image filtering/scaling mechanisms. Filtering might include tri-linear, bi-cubic, flat and bi-linear filtering. This mechanism also enables edge detection and enhancement.
If no callback is registered via this function, the magnification API will scale the bitmaps by the TRANSFORM specified to the SetWindowTransform.
Presentation system (e.g., Avalon) bitmaps can be scaled automatically using flat, bi-linear, bi-cubic filtering and consequently will not use this callback mechanism.
Note that one implementation of this function requires LDDM capable video cards; it will return false on XPDM.
   GetMagnifierImageFilterCallback
void (*GetMagnifierImageFilterCallback (HWND hwnd))(HWND hwnd, HANDLE bm, SIZE *bs);
Returns the registered callback function. If no callback is registered, the function returns NULL.
Note: This function requires LDDM capable video cards. It will return null on XPDM.
   SetMagnifierColorEffectsShader
BOOL SetMagnifierColorEffectsShader (HWND hwnd,LPDIRECT3DPIXELSHADER9 ps);
This function sets/registers the pixel shader for external image color correction code. The pixel shader specified by ps will be run after image composition has taken place. If a pixel shader is registered, composited bitmaps will be processed in video memory using the pixel shader.
This mechanism will allow third parties to implement custom color correction and effects such as negative and high contrast.
Function returns false if the operation fails. Note: This function requires LDDM capable video cards. It will return false on XPDM.
   GetMagnifierColorEffectsShader (Beta 2)
LPDIRECT3DPIXELSHADER9 GetMagnifierColorEffectsShader (HWND hwnd);
Returns the registered pixel shader. If no pixel shader is registered, the function returns NULL.
Note that one implementation of this function requires LDDM capable video cards; it will return null on XPDM.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising:
a magnification engine, the magnification engine having an interface set comprising at least one interface by which an application program can couple to a magnification program.

2. The system of claim 1 wherein the application program couples to the magnification program by identifying a magnification window to the magnification engine.

3. The system of claim 2 wherein the magnification engine receives messages corresponding to the magnification window and provides data corresponding to those messages to the magnification program for magnification of output data.

4. The system of claim 1 further comprising a selective window component, such that only graphics-related data that correspond to a set of included source windows are processed for magnification.

5. The system of claim 1 further comprising a selective window component, such that only graphics-related data that correspond to a set of non-excluded source windows are processed for magnification.

6. The system of claim 1 wherein the magnification engine receives graphics primitives from a graphics stream, and wherein the magnification engine is coupled to at least one rasterizer for rasterizing the graphics primitives into bitmaps.

7. The method of claim 6 wherein the magnification engine modifies at least some of the graphics primitives prior to rasterization to accomplish magnification.

8. The method of claim 6 wherein the magnification engine modifies at least some of the graphics primitives after rasterization to accomplish magnification and/or other effects.

9. The method of claim 1 wherein the magnification engine registers to receive windowing messages.

10. A computer-readable medium having computer-executable instructions, which when executed perform steps, comprising:
receiving a request to display a region of displayed graphics as modified by a transform;
receiving data corresponding to graphics commands for that region; and
processing the graphics commands so that a program-specified output area shows a transformed representation of the region.

11. The computer-readable medium of claim 10 having further computer-executable instructions comprising, receiving an identifier of a window to obtain the program-specified output area.

12. The computer-readable medium of claim 10 having further computer-executable instructions comprising, receiving a set of at least one window to include for transformation of at least part thereof when within the region.

13. The computer-readable medium of claim 10 having further computer-executable instructions comprising, receiving a set of at least one window to exclude from transformation when at least part thereof is within the region, and filtering each window of the set from trasnformed output corresponding thereto.

14. The computer-readable medium of claim 10 wherein receiving the request to display the region of displayed graphics as modified by the transform includes receiving data identifying the region and data identifying the transform.

15. The computer-readable medium of claim 10 wherein receiving the request to display the region of displayed graphics as modified by the transform includes receiving data identifying the region, receiving data identifying the transform, and filtering information corresponding to inclusion and/or exclusion of a set of at least one window with respect to magnification of content therein.

16. The computer-readable medium of claim 10 wherein processing the graphics commands comprises providing the commands to at least one magnification component to transform the commands such that rasterization of the commands results in be magnified output.

17. The computer-readable medium of claim 10 wherein processing the graphics commands comprises rasterizing at least some of the graphics commands into a resulting bitmap prior to providing the bitmap to a component for transformation.

18. In a computing environment, a system comprising:
a graphics server that receives immediate mode graphics primitives from a first program and retained mode primitives from a second program;
a magnification engine coupled to the graphics server, the magnification engine having an interface set comprising at least one interface for coupling to a magnification program; and
a composition engine coupled for communication with the graphics engine, the graphics engine providing at least some data corresponding to the immediate mode graphics primitives and retained mode primitives to the magnification program for magnification prior to sending to the composition engine for composing graphical output including magnified output.

19. The system of claim 18 further comprising an effects component that modifies data with at least one effect prior to final composing of the graphical output by the composition engine.

20. The system of claim 18 further comprising an image filter that routes immediate mode graphics to a rasterizer prior to sending to the composition engine.
